(19) United States
(12) Patent Application Publication
(10) Pub. No.: US 2008/0034819 A1
(43) Pub. Date: Feb. 14, 2008

(54) Rotation restricted locking apparatus and method

(75) Inventor: Norman Binz DeWalch, Houston, TX (US)

Correspondence Address: DEWALCH TECHNOLOGIES, INC., 6850 WYNNWOOD LANE, HOUSTON, TX, 77008, US

(73) Assignee: DeWalch Technologies, Inc.

(21) Appl. No.: 11/800,862

(22) Filed: May 7, 2007

Related U.S. Application Data
(62) Division of application No. 11/027,320, filed on Dec. 30, 2004, now Pat. No. 7,213,424.
Application No. 11/027,320 is a continuation of application No. 10/441,145, filed on May 19, 2003, now abandoned.
Application No. 10/441,145 is a continuation of application No. 08/716,598, filed on Sep. 18, 1996, now abandoned.
Application No. 08/716,598 is a continuation-in-part of application No. 08/301,516, filed on Sep. 7, 1994, now Pat. No. 6,386,006.
Application No. 08/301,516 is a continuation-in-part of application No. 08/053,589, filed on Apr. 27, 1993, now abandoned.

(51) Int. Cl. E05B 65/00; B65D 55/14

(52) U.S. Cl. 70/164

(57) ABSTRACT

An example embodiment relates to preventing rotation of a barrel lock when opened by a key. At least one example embodiment includes a rotationally actuated barrel lock for securing electric meter boxes and the like, and a spring loaded clip for mounting inside the meter box. Lock actuation is characterized by rotation of a key relative to the lock. The barrel lock includes a head portion, and a smaller diameter shank portion with flatted areas thereon. The clip includes, in an example embodiment, a lock receiving opening with internal protrusions which engage the flatted areas on the lock shank, thereby preventing rotation of the lock when it is engaged by the key.

### CROSS-REFERENCE TO RELATED APPLICATIONS

This application is a divisional of Ser. No. 11/027,320, filed Dec. 30, 2004, which is a continuation of Ser. No. 10/441,145, filed May 19, 2003, now abandoned, which is a continuation of Ser. No. 08/716,598, filed Aug. 9, 2000, now abandoned, which is a continuation-in-part of Ser. No. 08/301,516, filed Sep. 7, 1994, now U.S. Pat. No. 6,386,006, which is a continuation-in-part of Ser. No. 08/053,589, filed Apr. 27, 1993, now abandoned, to which the instant application claims priority. All written material, figures, and other disclosure in each of the above-referenced applications to the extent permitted are hereby incorporated by reference.

### BACKGROUND OF THE INVENTION

This invention relates to barrel locks, specifically to means for preventing rotation of a barrel lock when opened by a key.

Barrel locks are used to secure meter rings like the ones shown in U.S. Pat. No. 4,702,093 (DeWalch, 1987), as well as a variety of other locking hardware. In the present disclosure, the term “locking hardware” is used to refer to any device which is secured by a barrel lock. A barrel lock, as defined in the present disclosure, is commonly characterized as having a generally cylindrical case with a head portion, a smaller diameter shank portion, and a shoulder portion interposed between the head and shank portions. The shank portion includes retaining means, usually a pair of retractable steel balls, to prevent extraction of the lock from the meter ring or other locking hardware when the lock is locked. Usually barrel locks are removed from the locking hardware when they are unlocked. In many cases removal of the lock is required for opening the locking hardware.

Many barrel locks, such as the one described in U.S. Pat. No. 4,289,000 (Nielsen, 1981), rely on axial movement of the key to actuate the lock. Although the operation of axially actuated locks is independent of lock rotation, these locks have a relatively small number of possible key codes, are often easy to pick, and require the use of a rather large and cumbersome key. To overcome these difficulties, barrel locks have been developed which are actuated by rotation of the key relative to the lock. In the present disclosure, this type of lock will be referred to as a “rotationally actuated barrel lock.”

The generally cylindrical shape of most barrel locks allows them to rotate freely within the locking hardware. Although rotationally actuated barrel locks have many advantages, their rotation within the locking hardware can potentially cause a problem during lock actuation. Whenever the torque required to unlock the lock is greater than the torque required to rotate the lock within the locking hardware, the entire lock will rotate with the key. Since no relative rotation occurs between the lock and the key, the lock remains locked. In this situation, the user is clearly in need of some means to induce the relative rotation of the lock and key.

Those of skill in the art will appreciate the example embodiments of the present invention which addresses the above needs and other significant needs the solution to which are discussed hereinafter.

### SUMMARY OF THE INVENTION

In at least one example of the invention, there is provided a method for the prevention of rotation of a rotationally actuated barrel lock, wherein the barrel lock is removable from locking hardware when unlocked. In at least one example, the barrel lock includes a head portion, a smaller diameter shank portion, a retractable retaining means, a shoulder portion disposed between the head portion and the shank portion, and at least one cooperative rotation restricting surface. The method comprises, in at least one example, receiving the barrel lock in locking hardware and contacting at least one cooperative rotation restricting surface of the barrel lock with at least a second rotation restricting surface on the locking hardware.

In a further example of the invention, the barrel lock further comprises retaining means located on a shank portion.

In another example of the invention, the contacting comprises maintaining non-permanent contact; while, in another embodiment, the contacting comprises maintaining permanent contact.

In yet a further example, the method further comprises locating the at least a second rotation restricting surface within locking hardware.

According to still a further example, the at least a second rotation restricting surface further comprises a complementary aperture and the receiving comprises receiving the barrel lock within the complementary aperture.

In yet a further example, the at least a second rotation restricting surface is attached to a key for the barrel lock.

In still at least one more example, the method further comprises securing the second rotation restricting surface outside of locking hardware.

In still another example, the at least one second rotation restricting surface comprises an essentially non-circular receiving aperture (for example, at least one flat surface).

According to yet a further example, the method further comprises securing the barrel lock to locking hardware (for example, restricting the removal of the barrel lock). In still a further example, the securing further comprises non-permanently securing.

In an even further example, the method further comprises securing the second rotation restricting surface to locking hardware (for example, clipping the rotation restricting surface to the locking hardware).

According to another example of the invention, there is provided a method of retrofitting locking hardware to receive a barrel lock with a cooperative rotation restricting surface. The method comprises providing at least a second rotation restricting surface, and securing the at least a second rotation restricting surface to the locking hardware.

In a further example of the invention, the shape of the second cooperative rotation restricting surface is essentially complementary to the cooperative rotation restricting surface of the barrel lock.

In a further example of the invention, the securing further comprises securing the at least a second rotation restricting surface within the locking hardware (for example, clipping the at least a second rotation restricting surface to the locking hardware, wedging the at least a second rotation restricting surface within the locking hardware, and/or pressing the at least a second rotation restricting surface within the locking hardware).

In further examples, the securing further comprises permanently securing or non-permanently securing.

In still yet a further example, the method comprises securing the at least a second rotation restricting surface outside of the locking hardware.

In another example of the invention, there is provided a method for securing a meter to a meter box with a barrel lock having a cooperative rotation restricting surface. The method comprises surrounding at least a portion of the meter box with a surrounding surface, surrounding at least a portion of the meter with the surrounding surface, securing the surrounding surface to the meter box, and maintaining contact of at least one cooperative rotation restricting surface of the barrel lock with at least a second rotation restricting surface on locking hardware.

According to at least one example, the surrounding surface comprises a meter ring.

According to yet a further example, the securing to the meter box comprises locking the surrounding surface.

In another example of the invention, there is provided a system for prevention of rotation of a rotationally actuated barrel lock within meter locking hardware. The system comprises a means for receiving the barrel lock, and a means for maintaining contact (permanent or non-permanent) of at least one cooperative rotation restricting surface of the barrel lock with at least a second rotation restricting surface on the meter locking hardware.

In a further example of the invention, the barrel lock comprises retaining means located on a shank portion.

According to an even further example, the system further comprises a means for locating said at least a second rotation restricting surface within locking hardware.

According to still an even further example, the at least a second rotation restricting surface further comprises a complementary aperture, and the means for receiving comprises a means for receiving the barrel lock within said complementary aperture.

In a further example, the at least a second rotation restricting surface is secured outside locking hardware.

According to still a further example, the system further comprises a means for securing the second rotation restricting surface outside of the locking hardware.

In at least one more example, the at least a second rotation restricting surface comprises an essentially non-circular receiving aperture.

In yet a further example, the system further comprises a means for securing the barrel lock to meter locking hardware.

In still yet a further example, the means for securing further comprises a means for restricting the removal of the barrel lock.

In still at least one more example, the system further comprises a means for securing the second rotation restricting surface to locking hardware (for example, a means for clipping the rotation restricting surface to the locking hardware).

In another example of the invention, there is provided a system of retrofitting locking hardware to receive a barrel lock with a cooperative rotation restricting surface. The system comprises a means for providing at least a second rotation restricting surface, and a means for securing the at least a second rotation restricting surface to the locking hardware.

In a further example of the invention, the shape of the cooperative rotation restricting surface is essentially complementary to the at least a second rotation restricting surface of the barrel lock. In at least one example, the at least a second rotation restricting surface comprises at least a first aperture.

In another example of the invention, there is provided a system for securing a meter to a meter box with a barrel lock having a cooperative rotation restricting surface. The system comprises a means for surrounding at least a portion of the meter box with a surrounding surface, a means for surrounding at least a portion of the meter with the surrounding surface, a means for securing the surrounding surface to the meter box, and a means for maintaining contact of at least one cooperative rotation restricting surface of the barrel lock with at least a second rotation restricting surface.

According to still another example of the invention, there is provided a system for securing a meter to a meter box with a barrel lock having a cooperative rotation restricting surface. The system comprises a means for surrounding at least a portion of the meter box with a surrounding surface, a means for surrounding at least a portion of the meter with the surrounding surface, a means for securing the surrounding surface to the meter box; and a means for maintaining contact of at least one cooperative rotation restricting surface of the barrel lock with at least a second rotation restricting surface on locking hardware.

In yet another example of the invention, the surrounding surface further comprises a meter ring.

According to still a further example, the means for securing to the meter box and the means for securing to the meter further comprises a means for locking the surrounding surface.

In another example of the invention, there is provided an apparatus for the prevention of rotation of a rotationally actuated barrel lock within meter locking hardware. The apparatus comprises at least one cooperative rotation restricting surface the barrel lock, and at least a second rotation restricting surface on the meter locking hardware.

In further example of the invention, the at least a second rotation restricting surface comprises an essentially non-circular surface, and the at least a second rotation restricting surface is essentially complementary with the cooperative rotation restricting surface of the barrel lock.

In still a further example, the cooperative rotation restricting surface of the barrel lock further comprises a flat.

In yet at least one more example, the cooperative rotation restricting surface of the barrel lock further comprises a prong.

In still at least one more example, the cooperative rotation restricting surface of the barrel lock further comprises a notch.

In still another example, the cooperative rotation restricting surface of the barrel lock further comprises a spline.

According to at least one more example, the barrel lock further comprises locking balls.

According to yet a further example, the at least a second rotation restricting surface is located within locking hardware.

According to still yet a further example, the at least a second rotation restricting surface further comprises at least one flat.

In still a further example, the at least a second rotation restricting surface further comprises at least one complementary spline.

In an even further example, the at least a second rotation restricting surface further comprises at least one prong.

In still an even further example, the at least a second rotation restricting surface further comprises at least one notch.

According to an even further example, the at least a second rotation restricting surface further comprises a shape whose interaction with the cooperative rotation restricting surface of the barrel lock prevents rotation.

According to still an even further example, the at least a second rotation restricting surface further comprises a complementary aperture.

In another example, the complementary aperture further comprises a non-circular aperture having flats.

In a further example, the at least a second rotation restricting surface is located outside locking hardware.

According to still another example, the aperture further comprises an enclosure lock.

In yet another example, the non-circular surface comprises a surface without uniform radius.

According to still a further example, the apparatus further comprises a spring clip comprising at least one flat spring, at least one flat plate, and a lock receiving opening, wherein the flat spring and the flat plate are in communication.

In at least one more example, the lock receiving opening is within the flat plate.

In yet a further example, the lock receiving opening further comprises at least one protrusion.

In still yet a further example, the at least one protrusion is bent.

In another example of the invention, there is provided an apparatus for retrofitting locking hardware to receive a barrel lock with a cooperative rotation restricting surface. The apparatus comprises at least one rotation restricting surface, and an attachment means for attaching the rotation restricting surface to the locking hardware.

In a further example of the invention, the shape of the rotation restricting surface is essentially complementary to a cooperative rotation restricting surface of the barrel lock.

In still another example, the attachment means further comprises a spring clip.

According to at least one more example, the rotation restricting surface further comprises at least one prong.

In another example of the invention, there is provided an apparatus for securing a meter to a meter box with barrel lock having a cooperative rotation restricting surface. The apparatus comprises a hoop; a housing connected to the hoop; and a second rotation restricting surface connected to the hoop.

According to a further example of the invention, the housing further comprises a front housing, a rear housing, and a sealing member.

In still a further example, the sealing member further comprises the second rotation restricting surface.

In an even further example, the housing further comprises flats.

In another example of the invention, there is provided an apparatus for securing a meter to a meter box with a barrel lock. The barrel lock has at least one cooperative rotation restricting surface. The apparatus comprises a cover plate, and a lock receptacle connected to the cover plate. Notably, the lock receptacle further comprises at least a second rotation restricting surface.

In a further example of the invention, the lock receptacle further comprises flats.

According to an even further example, the cover plate overlays a door to be locked.

In another example of the invention, there is provided a barrel lock comprising: a head portion and at least one cooperative rotation restricting surface.

In a further example of the invention, the at least one cooperative rotation restricting surface is located on a shank portion.

According to still another example, the at least one cooperative rotation restricting surface comprises a flat.

In yet another example of the invention, the at least one cooperative rotation restricting surface comprises a curve.

According to still a further example, the at least one cooperative rotation restricting surface comprises a surface with a non-uniform radius.

In at least one more example, the at least one cooperative rotation restricting surface comprises a spline.

In yet a further example, the at least one cooperative rotation restricting surface comprises a prong.

In still yet a further example, the prong is located generally opposite the end of the barrel lock that the key is inserted.

In yet at least one more example, the prong is located generally on the same end of the barrel lock that the key is inserted.

In still at least one more example, the at least one cooperative rotation restricting surface comprises at least one notch.

In still another example, the notch is located generally on the same end of the barrel lock that the key is inserted.

According to at least one more example, the notch is located generally opposite the end of the barrel lock that the key is inserted.

According to yet a further example, there is provided a method of prevention of rotation of a barrel lock. The barrel lock further comprises an essentially cylindrical case, a head portion, a smaller diameter shank portion, and a shoulder portion interposed between the head and shank portions, wherein the shank portion of the barrel lock comprises a cooperative surface. The method comprises providing a second cooperative surface, whose shape is essentially permanently cooperative with the cooperative surface of the shank portion of the barrel lock, and providing contact between the cooperative surface of the barrel lock and the second cooperative surface.

These and other objects, features, and advantages of example embodiments of the present invention will become apparent from the drawings, the descriptions given herein, and the appended claims. Further objects are also indicated herein in various example embodiments of the invention. However, it will be understood that the above-listed objectives and/or advantages of example embodiments are intended only as an aid in quickly understanding aspects of the example embodiments, are not intended to limit the embodiments of the invention in any way, and therefore do not form a comprehensive or restrictive list of objectives, and/or features, and/or advantages.

The content and disclosure of each of the following applications/publications to the extent permitted are specifically hereby incorporated by reference: U.S. patent application Ser. No. 11/027,320, filed Dec. 30, 2004; U.S. patent application Ser. No. 10/441,145, filed May 19, 2003; U.S. patent application Ser. No. 08/716,598, filed Aug. 9, 2000; U.S. patent application Ser. No. 08/301,516, filed Sep. 7, 1994, now U.S. Pat. No. 6,386,006; and U.S. patent application Ser. No. 08/053,589, filed Apr. 27, 1993.

There has thus been outlined, rather broadly, features of example embodiments of the invention in order that the detailed description thereof may be better understood, and in order that the present contribution to the art may be better appreciated. There are additional features of example embodiments of invention that will be described hereinafter.

In this respect, before explaining at least one example embodiment of the invention in detail, it is to be understood that the example embodiments are not limited in its application to the details of construction and to the arrangements of the components set forth in the following description or illustrated in the drawings. Various example embodiments are capable of other further embodiments and of being practiced and carried out in various ways. Also, it is to be understood that the phraseology and terminology employed herein are for the purpose of the description and should not be regarded as limiting.

To the accomplishment of the above and related objects, example embodiments of the invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the embodiments of the invention will become fully appreciated as the same becomes better understood when considered in conjunction with the accompanying drawings, and wherein:

FIG. 1 shows a cutaway view of a barrel lock installed in a typical meter box in accord with an example embodiment of the invention.

FIG. 2 shows an isometric view of a spring clip and barrel lock in accord with an example embodiment of the invention.

FIG. 3 shows an isometric view of a lock having flats on the shank in accord with an example embodiment of the invention.

FIG. 4 shows an isometric view of a spring clip in accord with an example embodiment of the invention.

FIG. 5 shows a cross-sectional top view of the embodiment shown in FIG. 2 in accord with an example embodiment of the invention.

FIG. 6 shows an assembled side view of the embodiment shown in FIG. 2 in accord with an example embodiment of the invention.

FIG. 7 shows an isometric view of a barrel lock having a notch on the shoulder in accord with an example embodiment of the invention.

FIG. 8 shows an isometric view of a pronged split bushing in accord with an example embodiment of the invention.

FIG. 9 shows a cross-sectional view of a split bushing installed in locking hardware in accord with an example embodiment of the invention.

FIG. 10 shows an isometric view of a flatted split bushing in accord with an example embodiment of the invention.

FIG. 11 shows an isometric view of a meter ring and barrel lock installed on a typical electric meter in accord with an example embodiment of the invention.

FIG. 12 shows a cross-sectional side view of the example embodiment of the meter ring and lock shown in FIG. 11 in accord with an example embodiment of the invention.

FIG. 13 shows an isometric view of a portion of the example embodiment of the meter ring shown in FIG. 11 in accord with an example embodiment of the invention.

FIG. 14 shows an isometric view of a meter box lock and barrel lock installed on a typical electric meter box in accord with an example embodiment of the invention.

FIG. 15 shows a cross-sectional view of the example embodiment of the meter box lock and barrel lock shown in FIG. 14 in accord with an example embodiment of the invention.

FIG. 16 shows a top view of the example embodiment of the meter box lock shown in FIG. 14 in accord with an example embodiment of the invention.

FIGS. 17a through 17h show various complementary shapes for the barrel lock shank and lock receptacle to prevent rotation of the lock in accord with an example embodiments of the invention.

While various example embodiments of the invention will be described herein, it will be understood that it is not intended to limit the invention to those embodiments. On the contrary, it is intended to cover all alternatives, modifications, and equivalents included within the spirit of the invention.

### DETAILED DESCRIPTION OF THE INVENTION

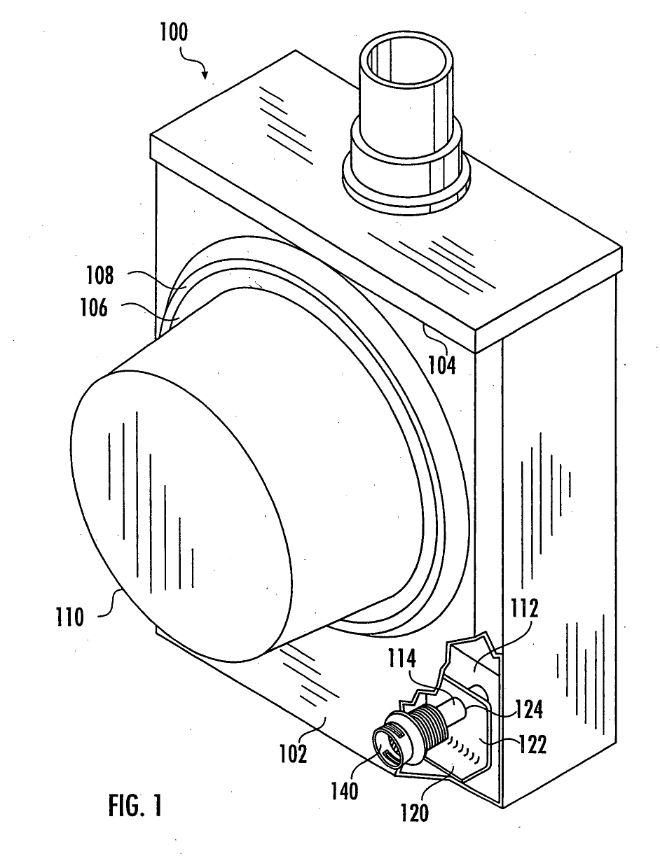

FIG. 1 shows a meter box 100 of the type commonly used in the utility industry. The door 102 of the box 100 is hinged generally at 104 and includes a central hole 106 with a surrounding boss 108 which serves to retain the meter 110. The bracket 120 is welded to the floor 112 of the box and includes a flat portion 122 with a lock receiving aperture 124 therethrough. The door 102 is usually secured with a barrel lock 114, which is inserted into the threaded flange 140 until the locking balls extend beyond the aperture 124 in the bracket 120.

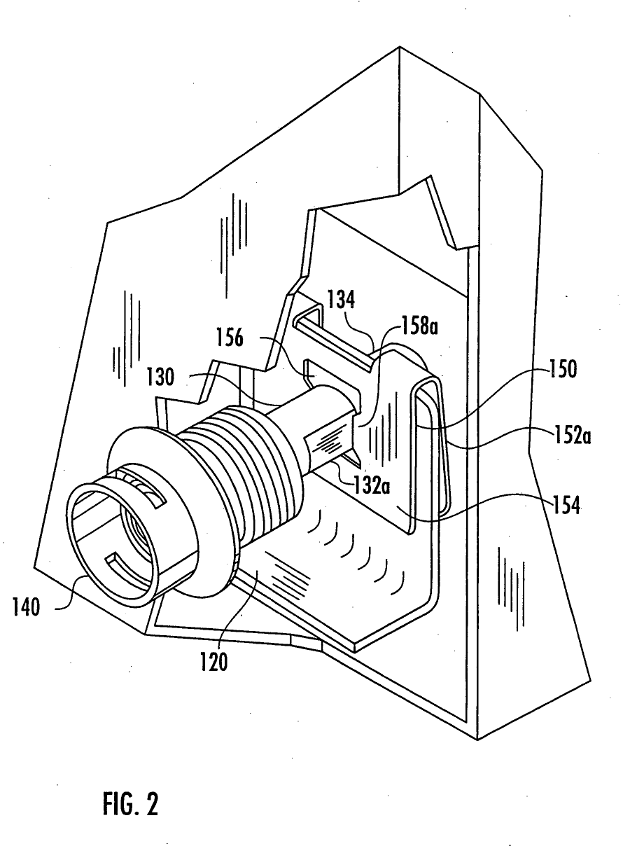

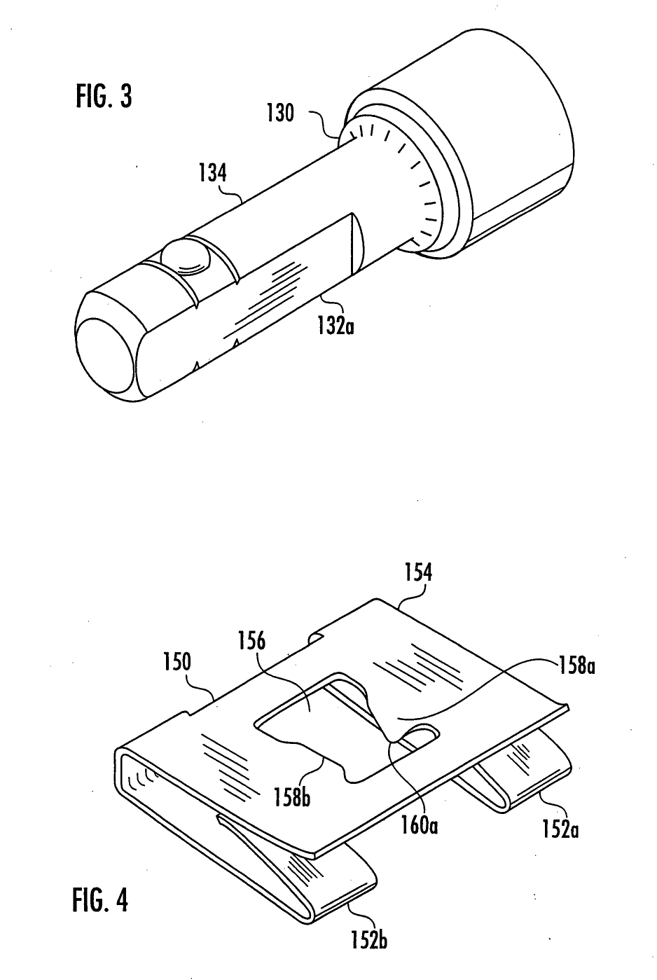

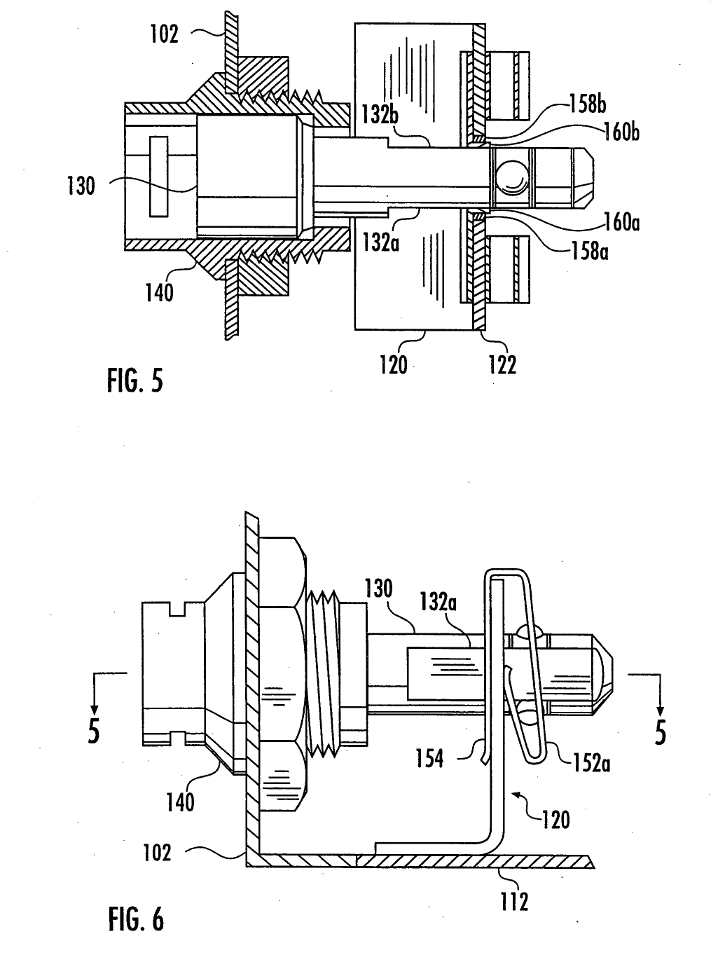

Referring to FIGS. 2 through 4, the present embodiment includes a modified lock 130 with two opposing flats such as 132a on the shank 134, and a spring clip 150 which is retrofitted onto the bracket 120. The spring clip 150 includes two flat spring portions 152a and 152b, and a flat plate portion 154 with a lock receiving opening 156 therein. Adjacent to the lock receiving opening 156 are two protrusions 158a and 158b, which include bent portions 160a and 160b, as shown in FIGS. 4 and 5. Referring to FIGS. 5 and 6, when the spring clip 150 is installed onto the bracket 120, the bent portions 160a and 160b extend into the lock receiving aperture 124 in the bracket 120. The flat spring portions 152a and 152b serve to maintain pressure between the flat plate portion 154 of the spring clip and the bracket, so that the bent portions 160a and 160b are retained in the aperture 124 and serve to secure the spring clip to the bracket. The protrusions 158a and 158b are sized and positioned to engage the flats 132a and 132b, respectively, on the shank 134 of the lock 130, and prevent rotation of the lock. In other embodiments, the clip or the original bracket could be constructed with any internal shaped means designed to engage the flats or other suitable shaped means on the lock case.

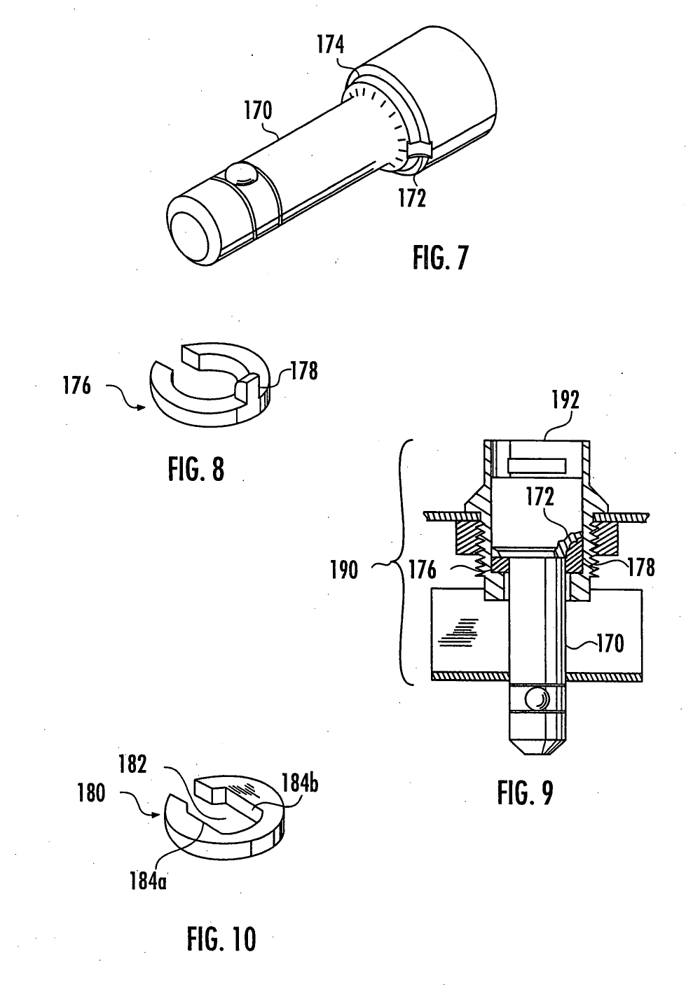

FIG. 7 shows an alternative embodiment barrel lock 170 having a notch 172 in the shoulder portion 174. FIG. 8 shows a split bushing 176, with a prong 178 designed to engage the notch 172 in the barrel lock 170. Referring to FIG. 9, the bushing 176 is pressed or otherwise non-rotatably installed in the lock receiving portion 192 of the locking hardware 190 prior to insertion of the lock 170. When the lock is inserted, the notch 172 engages the prong 178, and the lock is prevented from rotating. FIG. 10 shows a split bushing 180 having a central aperture 182 with internal flats 184a and 184b, which are designed to engage the flats 132a and 132b on the barrel lock 130 shown in FIG. 3. In other embodiments, any suitable shaped means could be used to non-rotatably couple the bushing and the barrel lock.

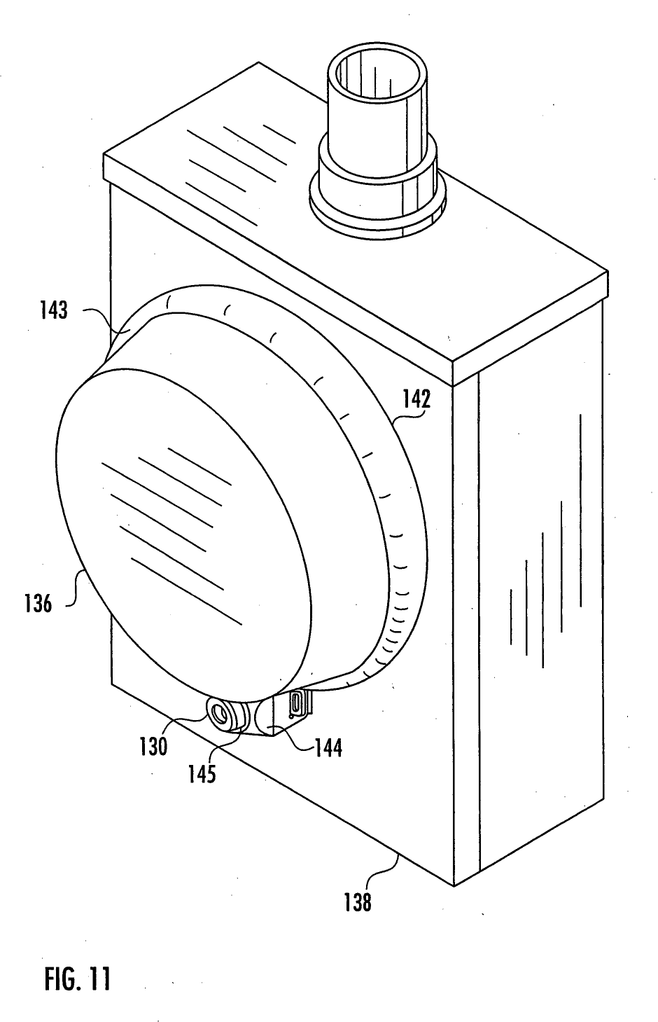

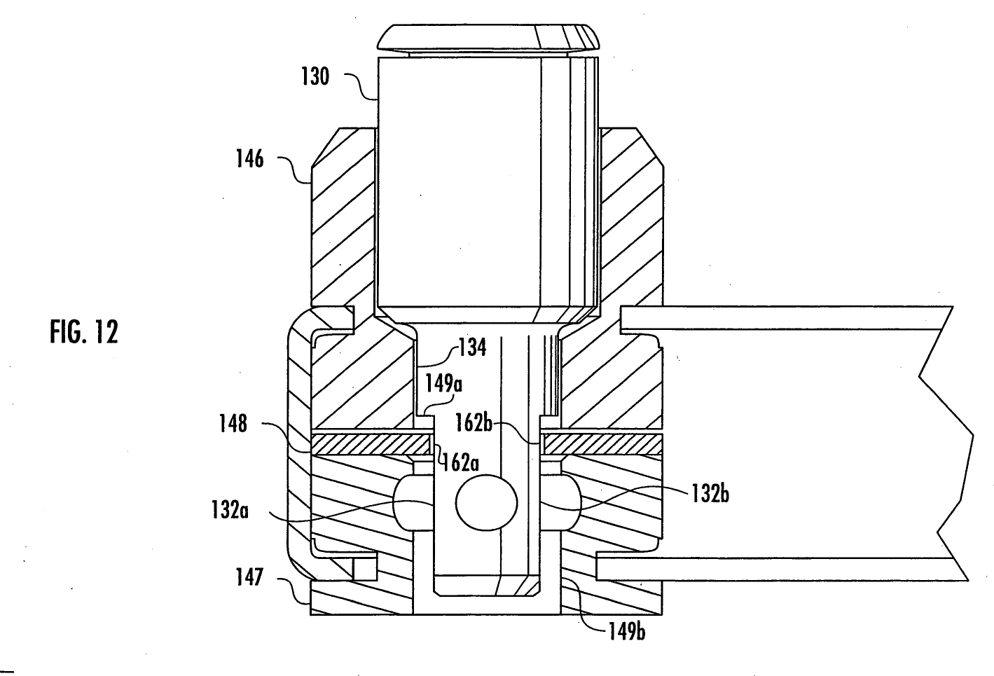

FIGS. 11 through 13 show a method for preventing lock rotation in meter locking rings. The meter locking rings or meter ring 142 shown in FIG. 11 retains the meter 136 on the meter box 138 in a manner well known in the industry. The meter ring includes a hoop portion 143, and a housing portion 144 with a lock receptacle 145 for receiving the preferred embodiment barrel lock 130. As shown in FIGS. 12 and 13, the housing portion includes a front housing 146, a rear housing 147, and a sealing member 148, which further include lock receiving apertures 149a, 149b, and 149c, respectively. Referring to FIG. 11, when the meter ring 142 is installed on the meter 136, the lock receiving apertures line up to form the lock receptacle 145 in the housing portion 144. The barrel lock 130 can then be inserted into the lock receptacle. Referring to FIG. 12, the barrel lock 130 has a shank portion 134 with flats 132a and 132b thereon. Referring to FIGS. 12 and 13, the lock receiving aperture 149c in the sealing member 148 has internal flatted areas 162a and 162b which engage the flats on the barrel lock, thus preventing the barrel lock from rotating when engaged by a key. In other embodiments, any of the lock receiving apertures which make up the lock receptacle could include the internal flats to engage the barrel lock.

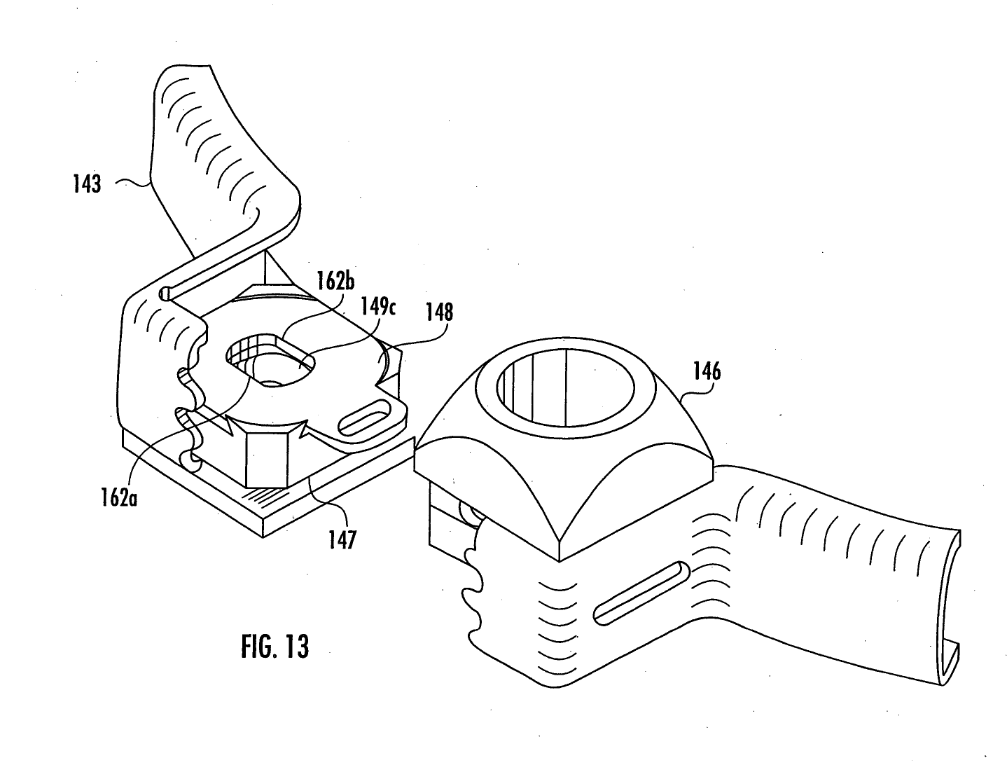

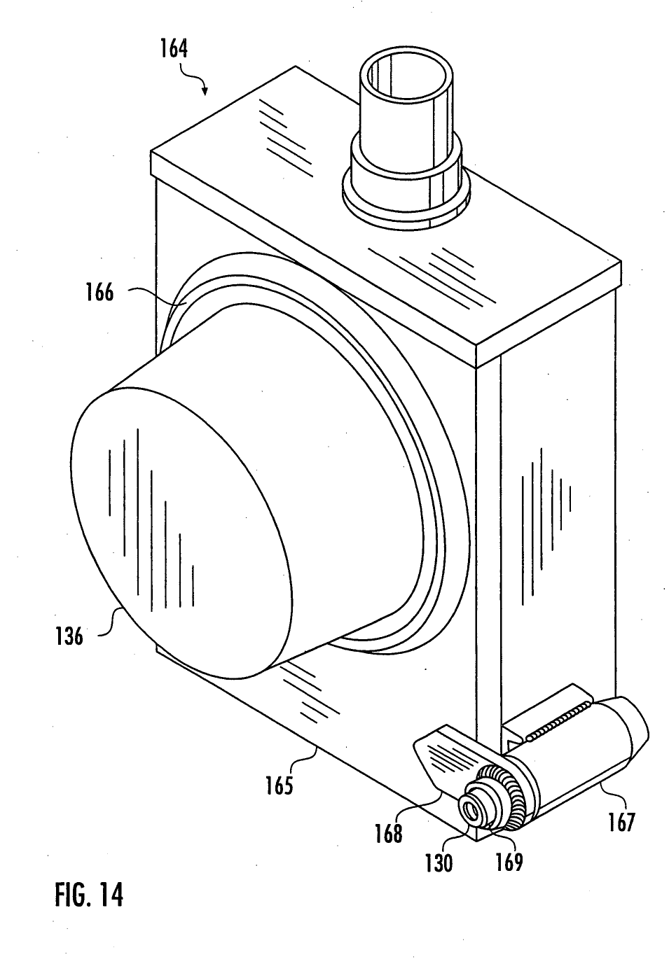

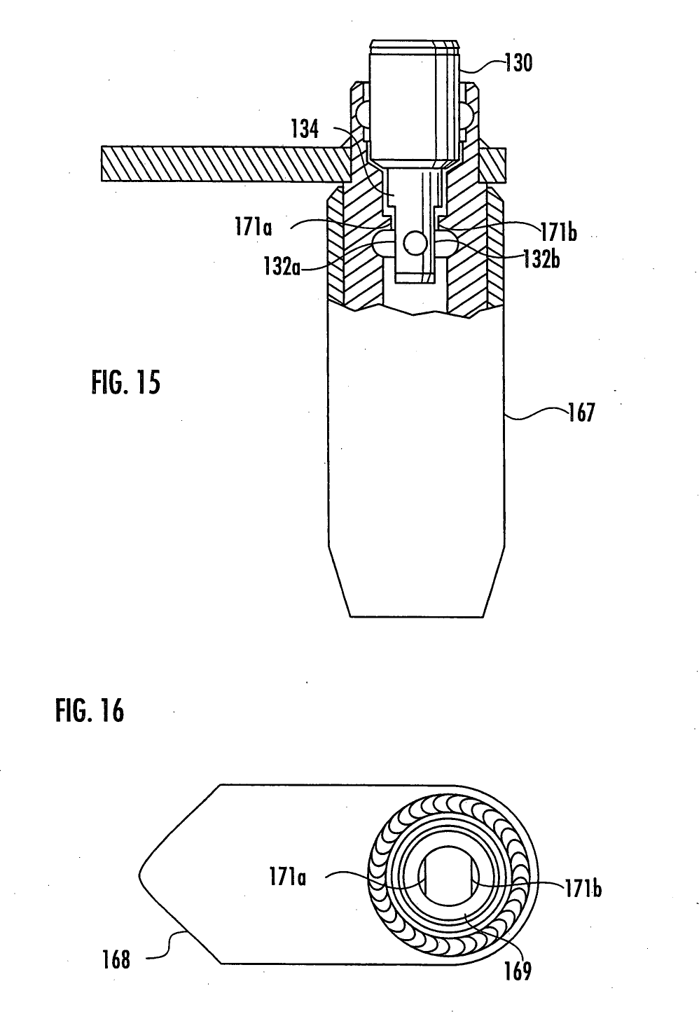

FIGS. 14 through 16 show a method for preventing lock rotation in meter box locks. The door 165 of the meter box 164 shown in FIG. 14 has a boss 166 which retains the meter 136 in the meter box. The meter box lock 167 retains the door in the closed position, in a manner well known in the industry. The meter box lock 167 includes a cover plate or similar member 168 which overlays the door 165 when the meter box lock is locked. The meter box lock also includes a lock receptacle 169 for receiving the barrel lock 130. Referring to FIG. 15, the barrel lock 130 has a shank portion 134 with flats 132a and 132b thereon. Referring to FIGS. 15 and 16, the lock receptacle 169 in the meter box lock includes internal flatted areas 171a and 171b which engage the flats on the barrel lock, thus preventing the barrel lock from rotating when engaged by a key.

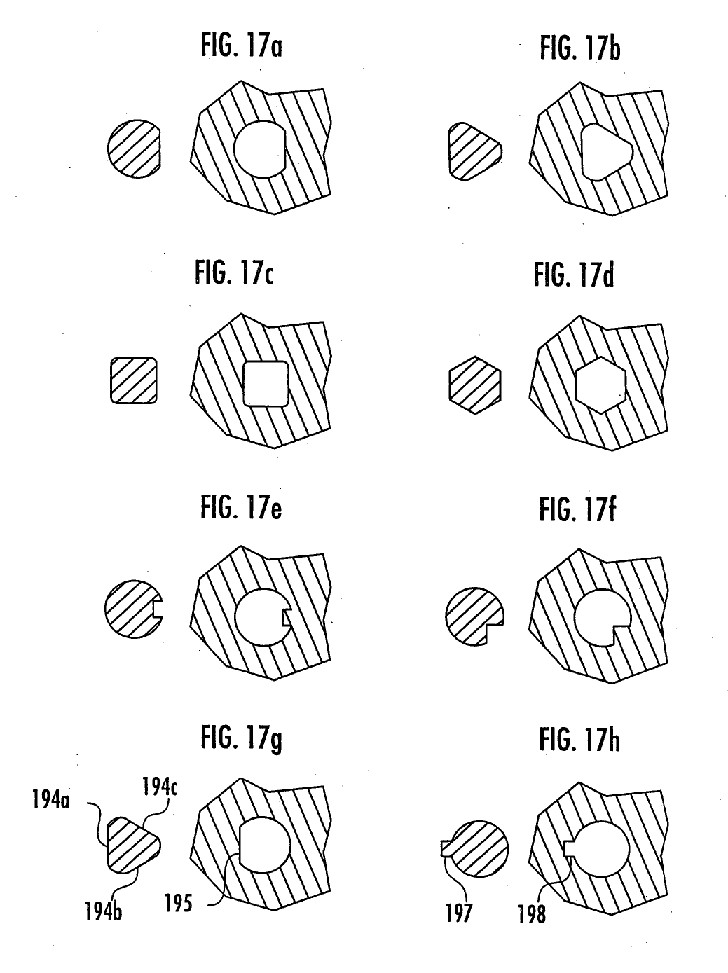

In other embodiments, any other suitable shape could be used in place of the flats on the lock shank and in the lock receptacle to prevent rotation of the lock in the locking hardware. FIGS. 17a through 17d show barrel lock shanks and lock receptacle using various numbers of flats. It should be understood that any number, size, or position of flats could be used without departing from the scope of the present invention. FIGS. 17e and 17f show barrel lock shanks with various longitudinal notches, and lock receptacles with complementary splines or prongs therein. FIG. 17h shows a lock shank with an external longitudinal spline 197, and a lock receptacle with complementary notch 198. Again, it should be understood that any number, size, shape, or position of notches and splines could be used without departing from the scope of the present invention.

It should also be understood that the barrel lock shank and lock receptacle need not have identical shapes, so long as the shape of the lock receptacle cooperates with the shape of the lock shank to prevent rotation of the barrel lock. FIG. 17g shows such an arrangement. The lock shank comprises three flats 194a, 194b and 194c, and the lock receptacle comprises a single flat 195. Although these shapes are certainly not identical, it is obvious that flat 195 could engage any of the flats 194a through 194c to prevent the barrel lock from rotating, and thereby achieve the objects of the present invention. It is intended that the scope of the present invention cover all combinations of lock shank shape and lock receptacle shape which cooperate to allow insertion of the lock shank into the lock receptacle but prevent rotation of the barrel lock relative to the locking hardware.

Various other example embodiments provide an apparatus that may be adapted for use on a utility service enclosure generally. Such a utility service enclosure may have various configurations, shapes and sizes and be used in the electric utility industry (e.g., a meter box) as well as in the gas, water, cable, TV utility industries or in other utility industries.

The design described does not limit the scope of the embodiments of invention; the number of various elements may change, or various components may be added or removed to the above-described concept, for example, to aid in improved security and operation.

The foregoing disclosure and description of embodiments of the invention is illustrative and explanatory of the above and variations thereof, and it will be appreciated by those skilled in the art, that various changes in the design, organization, order of operation, means of operation, equipment structures and location, methodology, the use of mechanical equivalents, such as different types of fasteners and locking devices than as illustrated whereby different steps may be utilized, as well as in the details of the illustrated construction or combinations of features of the various elements may be made without departing from the spirit of the embodiments of the invention. As well, the drawings are intended to describe various concepts of embodiments of the invention so that presently preferred embodiments of the invention will be plainly disclosed to one of skill in the art but are not intended to be manufacturing level drawings or renditions of final products and may include simplified conceptual views as desired for easier and quicker understanding or explanation of embodiments of the invention. As well, the relative size and arrangement of the components may be varied from that shown and the embodiments of the invention still operate well within the spirit of the embodiments of the invention as described hereinbefore and in the appended claims. Thus, various changes and alternatives may be used that are contained within the spirit of the embodiments of the invention.

Accordingly, the foregoing specification is provided for illustrative purposes only, and is not intended to describe all possible aspects of the example embodiments of the invention. It will be appreciated by those skilled in the art, that various changes in the ordering of steps, ranges, interferences, spacings, hardware, and/or attributes and parameters, as well as in the details of the illustrations or combinations of features of the methods and system discussed herein, may be made without departing from the spirit of the embodiments of the invention. Moreover, while various embodiments of the invention have been shown and described in detail, those of ordinary skill in the art will appreciate that changes to the description, and various other modifications, omissions and additions may also be made without departing from either the spirit or scope thereof.

What is claimed is:

1. A rotationally-actuated barrel lock for use with locking hardware comprising a rotation restricting stop surface, the barrel lock comprising:
a body comprising a head and a shank connected to said head;
at least one rotation restricting stop surface located on said body for interaction with the rotation restricting stop surface of the locking hardware; and
at least one variable-radial-play and radially-retractable retainer having an acute retaining surface, wherein the radial play allows the retainer to protrude through said body in a first condition and retract into said body in a second condition.
